(19) United States
(12) Patent Application Publication
(10) Pub. No.: US 2010/0021070 A1
(43) Pub. Date: Jan. 28, 2010

(54) COMMUNICATION DEVICE AND IMAGE CLASSIFICATION METHOD THEREOF

(75) Inventor: CHIA-TA LO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/487,560

(22) Filed: Jun. 18, 2009

(30) Foreign Application Priority Data
Jul. 23, 2008 (CN) 200810302955.7

(51) Int. Cl. G06K 9/62

(52) U.S. Cl. 382/224

(57) ABSTRACT

A communication device and method for classifying images include setting a plurality of image sorts and defining basic characteristics of each image sort, extracting an image from a received multimedia messaging service (MMS) message, and identifying at least one characteristic of the extracted image. The communication device and method further include determining an image sort for the extracted image by comparing the at least one identified characteristic with the basic characteristics of each image sort, and classifying the extracted image into the determined image sort.

### BACKGROUND

1. Technical Field

Embodiments of the present disclosure relate to communication devices and methods for images management, and more particularly to a communication device and method for classifying images in the communication device.

2. Description of Related Art

With rapid development of communication, portable electronic devices, such as mobile phones are now in widespread use. Mobile phones provide various functionalities for people, such as short message services, communications, games, calendars, music, etc. More and more people utilize mobile phones to communicate with others, or transmit data through various kinds of short messages, such as text messages and multimedia messaging service (MMS) messages. The MMS messages may include audio files, video files, text files, and/or images. How to manage the images received by the mobile phones is important for the people. Generally, people would like to store the received images in the mobile phones.

However, if more and more images are received or stored in the mobile phones, it is difficult for people to manage the images manually and conveniently, such as to classify the images, to store the images under different storage paths, etc.

What is needed, therefore, is an improved communication device and method for classifying the images automatically.

### BRIEF DESCRIPTION OF THE DRAWINGS

FIG. 1 is a block diagram of one embodiment of a communication device capable of classifying images.

FIG. 2 is a diagram of one embodiment of images received by the communication device in FIG. 1.

FIG. 3 is a flowchart of one embodiment of a method for classifying images in the communication device of FIG. 1.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

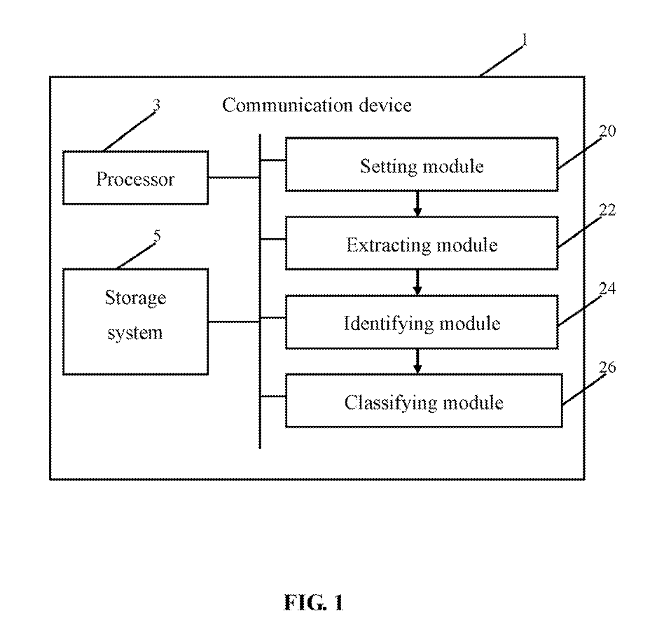

FIG. 1 is a block diagram of one embodiment of a communication device 1 capable of classifying images. In one embodiment, the communication device 1 includes a processor 3 and a storage system 5. The storage system 5 stores one or more programs, such as programs of an operating system, and other applications of the communication device 1. The storage system 5 further stores various kinds of data, such as received messages/E-mails, images etc. In one embodiment, the communication device 1 may be a mobile phone, and the storage system 5 may be a memory of the communication device 1 or an external storing card, such as a memory stick, a Subscriber Identification Module (SIM) card, a smart media card, a compact flash card, or any other type of memory card. The processor 3 executes programs of the communication device 1 and the other applications, to provide functions of the communication device 1.

The communication device 1 includes a setting module 20, an extracting module 22, an identifying module 24, and a classifying module 26. The modules 20, 22, 24, and 26 may be executed by the processor 3 to perform one or more operations of the communication device 1, i.e., classifying images received by the communication device 1.

The setting module 20 sets a plurality of image sorts to classify the images received by the communication device 1, and sets a storage path to store images of each image sort. In one embodiment, the plurality of image sorts may include portraits, urban, nature, etc.

The setting module 20 also defines basic characteristics of each image sort, and sets a threshold ratio to identify a similarity between characteristics of an image with the basic characteristics of each image sort. In one embodiment, an image sort of “portraits” may include the basic characteristics of eyes, a nose, a mouth of a person, and so on; an image sort of “urban” may include the basic characteristics of buildings, roads, and so on; an image sort of “nature” may include the basic characteristics of mountains, rivers, and so on.

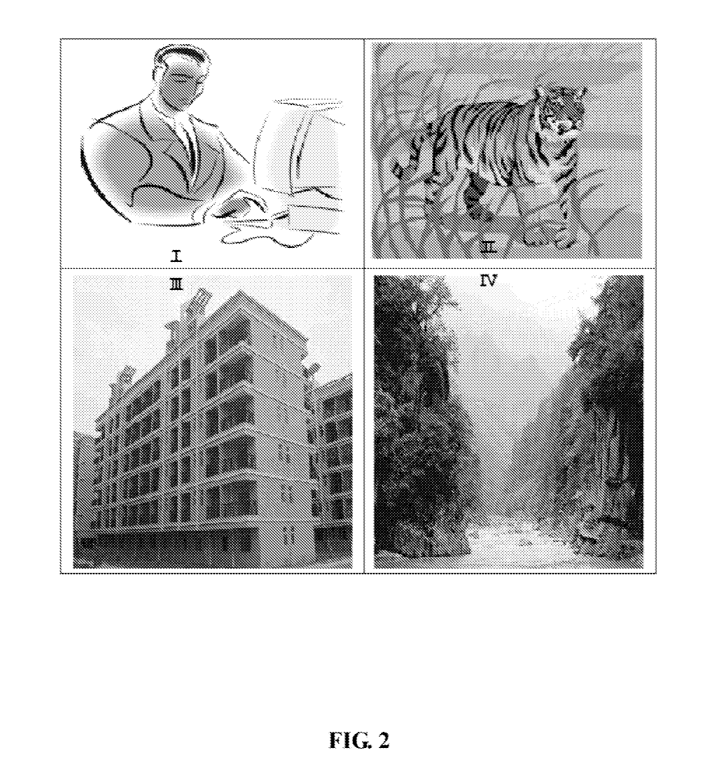

The setting module 20 further sets a misc image sort for images not having characteristics that match the basic characteristics of the plurality of image sorts, and sets a misc image storage path to store images of the misc image sort into the storage system 5. In one embodiment, if the characteristics of an image do not match the basic characteristics of any image sort, the image may be classified into the misc image sort. Referring to FIG. 2, there are four images: the first image belongs to the image sort of “portraits,” the second image belongs to the misc image sort, the third image belongs to the image sort of “urban,” and the fourth image belongs to the image sort of “nature.”

The extracting module 22 determines if the communication device 1 receives a multimedia messaging service (MMS) message. If the communication device 1 receives a MMS message, the extracting module 22 decodes the MMS message by using the Synchronized Multimedia Integration Language (SMIL). SMIL is a markup language developed by the World Wide Web Consortium (W3C) which can divide multimedia content into separate files and streams, such as audio, video, text, and images, etc., send the separate files and streams to a computer individually, and then have the separate files and streams displayed together as if the separate files and streams were a single multimedia stream.

The extracting module 22 determines if the MMS message includes an image after decoding the MMS message, and extracts the image from the MMS message if the MMS message includes an image.

The identifying module 24 identifies at least one characteristic of the extracted image, compares the at least one identified characteristic with the basic characteristics of each image sort, and calculates at least one matching ratio between the identified characteristic and the basic characteristics of each image sort.

The identifying module 24 also determines if any matching ratio is not less than the threshold ratio. If a matching ratio is not less than the threshold ratio, the identifying module 24 determines the basic characteristics corresponding to the matching ratio, and determines the image sort having the determined basic characteristics. The classifying module 26 classifies the extracted image into the determined image sort, and stores the extracted image into the storage system 5 according to the storage path corresponding to the determined image sort.

In one embodiment, the threshold ratio is set as 80%, and the identified characteristics include portraits and nature. If a matching ratio between the portrait with the basic characteristics of the image sort of “portraits” is 85%, and a matching ratio between the nature with the basic characteristics of the image sort of “nature” is 50%, the classifying module 26 classifies the extracted image into the image sort of “portrait.”

In one embodiment, a means of integral features identification and a means of local features identification are used to identify a portrait in an image. The means of integral features identification regards a face as a single feature to be identified. The means of local features identification separates local features (i.e., eyes, a nose, a mouth, etc.) from the face, and identifies the separated local features respectively. Then the means of local features identification further acquires multiple identification results, and integrates the multiple identification results thereby generating an integrative identification result. Face features detecting technologies include the technology of principal component analysis (PCA), the technology of color analysis, the technology of Hough transform, the technology of neural networks, the technology of motion extraction, and the technology of template matching, etc. The face features detecting technologies may be classified into three sorts of view-based approaches, statistic, and learning-based approaches.

If no matching ratio is not less than the threshold ratio, the classifying module 26 classifies the extracted image into the image sort of “misc image sort,” and stores the extracted image into the storage system 5 according to the misc image storage path.

If more than one matching ratios are not less than the threshold ratio, the identifying module 24 determines more than one image sorts according to the basic characteristics corresponding to the more than one matching ratios. The classifying module 26 classifies the extracted image into any one of the determined multiple image sorts, and stores the extracted image into the storage system 5 according to the storage path corresponding to the classified image sort. In another embodiment, the setting module 20 may set priority orders for the image sorts. Therefore, if more than one image sorts are determined, the classifying module 26 may classify the extracted image into an image sort having a higher priority.

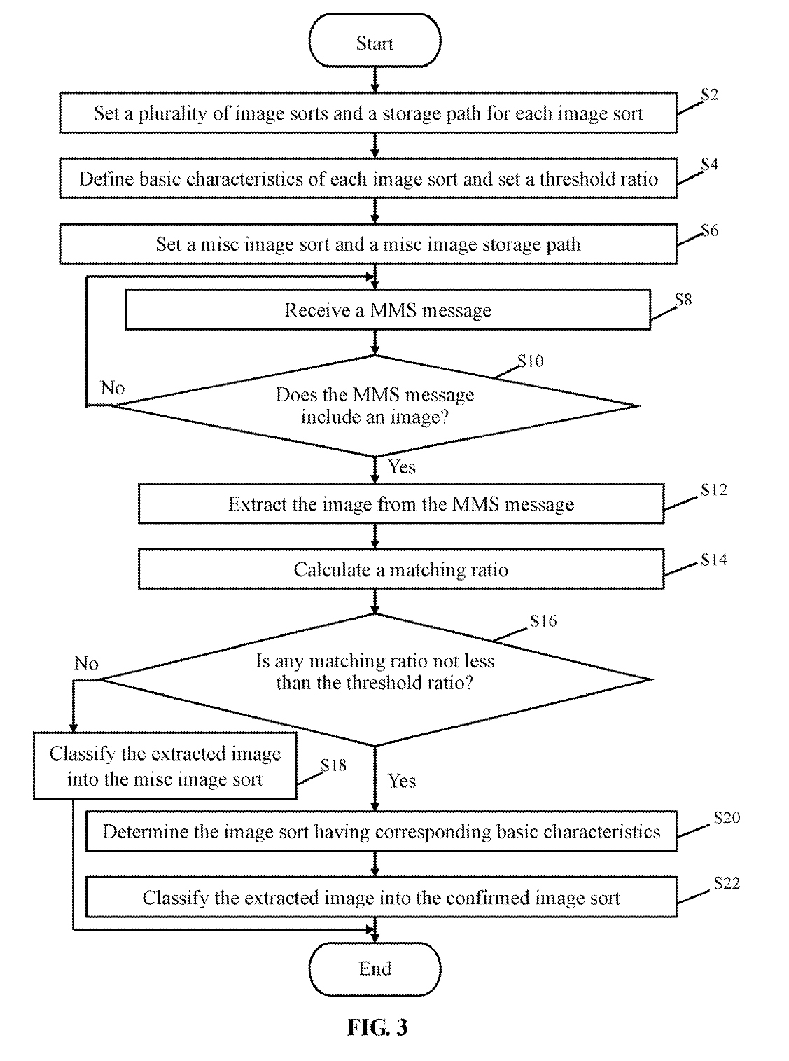

FIG. 3 is a flowchart of one embodiment of a method for classifying images in the communication device 1 of FIG. 1. Depending on the embodiment, additional blocks may be added, others removed, and the ordering of the blocks may be replaced.

In block S2, the setting module 20 sets a plurality of image sorts to classify the images received by the communication device 1, and sets a storage path to store images of each image sort. In one embodiment, the plurality of image sorts may include portraits, urban, nature, etc. As mentioned above, FIG. 2 shows four images belonging to different image sorts.

In block S4, the setting module 20 defines basic characteristics of each image sort, and sets a threshold ratio to identify a similarity between characteristics of an image with the basic characteristics of each image sort.

In block S6, the setting module 20 sets a misc image sort for images not having characteristics that match the basic characteristics of the plurality of image sorts, and sets a misc image storage path to store images of the misc image sort. As shown in FIG. 2, the second image belongs to the misc image sort.

In block S8, the communication device 1 receives a MMS message. In block S10, the extracting module 22 decodes the MMS message by using the Synchronized Multimedia Integration Language (SMIL), and determines if the MMS message includes an image.

If the MMS message includes an image, in block S12, the extracting module 22 extracts the image from the MMS message.

In block S14, the identifying module 24 identifies at least one characteristic of the extracted image, compares the at least one identified characteristic with the basic characteristics of each image sort, and calculates at least one matching ratio between the identified characteristic and the basic characteristics of each image sort.

In block S16, the identifying module 24 determines if any matching ratio is not less than the threshold ratio.

If no matching ratio is not less than the threshold ratio, in block S18, the classifying module 26 classifies the extracted image into the misc image sort, and stores the extracted image into the storage system 5 according to the misc image storage path.

If there is a matching ratio is not less than the threshold ratio, in block S20, the identifying module 24 determines the basic characteristics corresponding to the matching ratio, and determines the image sort having the determined basic characteristics.

In block S22, the classifying module 26 classifies the extracted image into the determined image sort, and stores the extracted image into the storage system 5 according to the storage path corresponding to the determined image sort.

In another embodiment, if more than one matching ratios are not less than the threshold ratio, the identifying module 24 determines more than one image sorts according to the basic characteristics corresponding to the multiple matching ratios, and the classifying module 26 classifies the extracted image into any one of the determined more than one image sorts, and store the extracted image into the storage system 5 according to the storage path corresponding to the classified image sort.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for classifying images received by a communication device, the method comprising:
setting a plurality of image sorts to classify the images received by the communication device, and setting a storage path to store images of each image sort into a storage system of the communication device;
defining basic characteristics of each image sort, and setting a threshold ratio to identify a similarity with the basic characteristics of each image sort;
decoding a received multimedia messaging service (MMS) message, and extracting an image from the MMS message;
identifying at least one characteristic of the extracted image;
comparing the at least one identified characteristic with the basic characteristics of each image sort to calculate at least one matching ratio of the extracted image with each image sort;
determining if there is a matching ratio not less than the threshold ratio;
determining the basic characteristics corresponding to the matching ratio if there is a matching ratio not less than the threshold ratio;
determining the image sort having the determined basic characteristics; and
classifying the extracted image into the determined image sort, and storing the extracted image into the storage system according to the storage path corresponding to the determined image sort.

2. The method according to claim 1, further comprising:
if there are more than one matching ratios not less than the threshold ratio, determining more than one image sorts according to the basic characteristics corresponding to the more than one matching ratios; and
classifying the extracted image into one of the determined more than one image sorts, and storing the extracted image into the storage system according to the storage path corresponding to the classified image sort.

3. The method according to claim 1, further comprising:
setting a misc image sort for images not having characteristics that match the basic characteristics of the plurality of image sorts, and setting a misc image storage path to store images of the misc image sort into the storage system of the communication device.

4. The method according to claim 3, further comprising:
classifying the extracted image into the misc image sort if there is no matching ratio not less than the threshold ratio; and
storing the extracted image into the storage system according to the misc image storage path.

5. The method according to claim 1, wherein the MMS message is decoded by using the Synchronized Multimedia Integration Language to divide multimedia content of the MMS message into separate files and streams including audio, video, texts, and images.

6. A communication device capable of classifying images, the communication device comprising:
a storage system;
at least one processor; and
one or more programs stored in the storage system and being executable by the at least one processor, the one or more programs comprising:
a setting module operable to set a plurality of image sorts to classify the images received by the communication device, set a storage path to store images of each image sort into the storage system, define basic characteristics of each image sort, and set a threshold ratio to identify a similarity with the basic characteristics of each image sort;
an extracting module operable to decode a received multimedia messaging service (MMS) message, and extract an image from the MMS message;
an identifying module operable to identify at least one characteristic of the extracted image, compare the at least one identified characteristic with the basic characteristics of each image sort to calculate at least one matching ratio of the extracted image with each image sort, determine that there is a matching ratio not less than the threshold ratio and determine the basic characteristics corresponding to the matching ratio, and determine the image sort having the determined basic characteristics; and
a classifying module operable to classify the extracted image into the determined image sort, and store the extracted image into the storage system according to the storage path corresponding to the determined image sort.

7. The communication device according to claim 6, wherein the identifying module is further operable to determine that there are more than one matching ratios not less than the threshold ratio, determine more than one image sorts according to the basic characteristics corresponding to the more than one matching ratios, classify the extracted image into one of the determined more than one image sorts, and store the extracted image into the storage system according to the storage path corresponding to the classified image sort.

8. The communication device according to claim 6, wherein the setting module is further operable to set a misc image sort for images not having characteristics that match the basic characteristics of the plurality of image sorts, and set a misc image storage path to store images of the misc image sort into the storage system of the communication device.

9. The communication device according to claim 8, wherein the identifying module is further operable to determine that there is no matching ratio not less than the threshold ratio, and the classifying module is further operable to classify the extracted image into the misc image sort, and store the extracted image into the storage system according to the misc image storage path.

10. The communication device according to claim 6, wherein the extracting module is further operable to determine if the communication device receives a MMS message.

11. The communication device according to claim 6, wherein the extracting module decodes the MMS message using the Synchronized Multimedia Integration Language to divide multimedia content of the MMS message into separate files and streams including audio, video, texts, and images.

12. A storage medium storing a set of instructions, the set of instructions capable of being executed by a processor to perform a method of classifying images received by a communication device, the method comprising:
setting a plurality of image sorts to classify the images received by the communication device, and setting a storage path to store images of each image sort into a storage system of the communication device;
defining basic characteristics of each image sort, and setting a threshold ratio to identify a similarity with the basic characteristics of each image sort;
decoding a received multimedia messaging service (MMS) message, and extracting an image from the MMS message;
identifying at least one characteristic of the extracted image;
comparing the at least one identified characteristic with the basic characteristics of each image sort to calculate at least one matching ratio of the extracted image with each image sort;
determining if there is a matching ratio not less than the threshold ratio;
determining the basic characteristics corresponding to the matching ratio if there is a matching ratio not less than the threshold ratio;
determining the image sort having the determined basic characteristics; and
classifying the extracted image into the determined image sort, and storing the extracted image into the storage system according to the storage path corresponding to the determined image sort.

13. The storage medium as claimed in claim 12, wherein the method further comprises:
if there are more than one matching ratios not less than the threshold ratio, determining more than one image sorts according to the basic characteristics corresponding to the more than one matching ratios; and
classifying the extracted image into one of the determined more than one image sorts, and storing the extracted image into the storage system according to the storage path corresponding to the classified image sort.

14. The storage medium as claimed in claim 12, wherein the method further comprises:
setting a misc image sort for images not having characteristics that match the basic characteristics of the plurality of image sorts, and setting a misc image storage path to store images of the misc image sort into the storage system of the communication device.

15. The storage medium as claimed in claim 14, wherein the method further comprises:
classifying the extracted image into the misc image sort if there is no matching ratio not less than the threshold ratio; and
storing the extracted image into the storage system according to the misc image storage path.

16. The storage medium as claimed in claim 12, wherein the MMS message is decoded by using the Synchronized Multimedia Integration Language to divide multimedia content of the MMS message into separate files and streams including audio, video, texts, and images.
